(19) United States
(12) Patent Application Publication
(10) Pub. No.: US 2022/0413941 A1
(43) Pub. Date: Dec. 29, 2022

(54) COMPUTING CLUSTERS

(71) Applicant: Hewlett-Packard Development Company, L.P., Spring, TX (US)

(72) Inventors: Ravindra Ramtekkar, Pune (IN); Narendra Kumar Chincholikar, Pune (IN); Mayuri Mohite, Pune (IN)

(21) Appl. No.: 17/850,534

(22) Filed: Jun. 27, 2022

(30) Foreign Application Priority Data
Jun. 29, 2021 (IN) 202141029199

(51) Int. Cl. G06F 9/50; G06F 9/48; G06N 5/02

(52) U.S. Cl. CPC G06F 9/5083; G06F 9/5016; G06F 9/4887; G06N 5/022

(57) ABSTRACT

In one example in accordance with the present disclosure, an electronic device is described. An example electronic device includes a processor and memory storing executable instructions that when executed cause the processor to determine availability of memory resources and processing resources of multiple computing devices. The instructions also cause the processor to form a computing cluster based on the availability of the memory resources and the processing resources. The instructions further cause the processor to assign a computing task to the computing cluster to replace a cloud service.

### BACKGROUND

Electronic technology has advanced to become virtually ubiquitous in society and has been used to improve many activities in society. For example, electronic devices are used to perform a variety of tasks, including work activities, communication, research, and entertainment. Different varieties of electronic circuits may be utilized to provide different varieties of electronic technology.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an electronic device to form a computing cluster based on available memory resources and processing resources, according to an example.

FIG. 2 is a block diagram illustrating a system for generating a computing cluster, according to an example.

FIG. 3 is a flow diagram illustrating a method for forming a computing cluster based on memory resources and processing resources, according to an example.

FIG. 4 depicts a non-transitory machine-readable storage medium for generating a computing cluster based on memory resources and processing resources, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Computing devices may include memory resources and processing resources to perform computing tasks. For example, memory resources may include volatile memory (e.g., random access memory (RAM)) and non-volatile memory (e.g., read-only memory (ROM), data storage devices (e.g., hard drives, solid-state devices (SSDs), etc.) to store data and instructions. In some examples, processing resources may include circuitry to execute instructions. Examples of processing resources include a central processing unit (CPU), a graphics processing unit (GPU), or other hardware device that executes instructions.

In many circumstances, a computing device may use a portion of its memory resources and processing resources. For example, on average, a computing device may use 15% of its CPU and 55% of its RAM when a user is using a computing device. Furthermore, when the computing device is idle, e.g., at night when a user is asleep, the memory resources and processing resources may be unused. The unused processing resources and memory resources of the computing device can be donated, with consent from the user of the computing device, to form an on-premises computing cluster. As used herein, a computing cluster is a set of computing devices that work together to perform a computing task or multiple computing tasks. The computing devices in the computing duster may operate as a single system. In some examples, a computing duster may be utilized to process heavy data processing jobs.

In some examples, the computing duster may be used to reduce costs associated with cloud services. For example, an organization may send computing tasks to be performed by a computing service (e.g., Amazon Web Services® (AWS), Microsoft® Azure®, Google Cloud Platform® (GCP), etc.). However, the cloud services may charge fees to perform the computing tasks. Therefore, to reduce costs associated with cloud services, a computing cluster may be formed from unused or underutilized computing resources within an organization. For example, a business may have several employees, who each have a computing device. In this case, the business may form a computing cluster from those computing devices when the memory resources and processing resources are available. Most of the time, these resources may be idle or used below their capacity.

Therefore, these resources can be utilized to their full capacity by sharing them and forming a cluster of those resources, referred to herein as a computing cluster. In some examples, these computing clusters can be used as an on-premises data center to provide, flexibility when determining whether to use the cloud services. In some examples, the computing clusters may allow an organization to use the computing devices to their full potential. Moreover, in the case of cloud service downtime or when latency on a cloud service is extremely high, the computing cluster may help to carry out and execute computing tasks by providing flexible resource allocation.

The examples described herein use a Machine Learning approach to allocate what will be the best fit for a given application (i.e., computing task) to execute successfully. With that, the described examples enable monitoring an entire population of memory resources and processing resources to reduce the resources from being underutilized.

The examples described herein provide an artificial intelligence (AI)-based approach to analyze computing device memory resources and processing resources to form an on-premises computing cluster. In some examples, focusing on using memory resources (e.g. RAM) and processing resources (e.g., CPU) may provide cost savings, as these components may be the expensive components of the computing device.

in some examples, historical processing resource usage (e.g., CPU usage) and memory resource usage may be collected from multiple computing devices. A machine-learning (ML) model may be trained to predict the availability of the memory resources and processing resources. This prediction may be performed on a daily basis for each computing device that could be donated to the computing cluster. Based on the ML model prediction, an inventory of idle computing devices with available memory resources and processing resources may be created (e.g., by a ML model running on a server). The server may coordinate with each computing device and acquire actual availability of memory resources and processing resources to build a pool of computing devices to process a computing task or a batch of computing tasks without affecting users' ongoing activities. This pool of computing devices may be the computing cluster.

If the server identifies a sufficient availability of memory resources and processing resources to run heavy computing tasks, then the server may coordinate with the computing devices to complete the computing task. In some examples, the server may release the memory resources and processing resources upon completion of the computing task and will wait for next computing task or set of computing tasks. In some examples, the computing devices may be assigned in a round robin fashion to balance the load efficiently and to provide equal opportunity to computing devices to donate memory resources and processing resources. If for some reason the predicted memory resources and processing resources are not available at the scheduled time for a given computing task, then the computing task may be executed on a paid cloud service to ensure that the computing task gets completed. By utilizing the available memory resources and processing resources to form a computing cluster, an organization may increase planning capacity, reduce cloud service costs, and may move more computing tasks to the on-premises computing cluster.

The present specification describes examples of an electronic device. The electronic device includes a processor. In this example, the processor is to determine availability of memory resources and processing resources of multiple computing devices. The processor may form a computing cluster based on the availability of the memory resources and the processing resources. The processor may also assign a computing task to the computing cluster to replace a cloud service.

In another example, the present specification also describes an electronic device. The electronic device includes a processor. In this example, the processor is to run an ML model trained to predict availability of memory resources and processing resources of multiple computing devices. The processor is to schedule a computing task based on the predicted availability of the memory resources and the processing resources. The processor is to form, responsive to scheduling the computing task, a computing cluster based on actual availability of the memory resources and the processing resources. The processor is also to assign the computing task to be performed by the computing cluster.

In yet another example, the present specification also describes a non-transitory machine-readable storage medium that includes instructions, when executed by a processor of an electronic device, cause the processor to run an ML model trained to predict availability of memory resources and processing resources of multiple computing devices. The instructions also cause the processor to form a computing cluster based on the predicted availability of the memory resources and processing resources of multiple computing devices. The instructions further cause the processor to determine a first portion of a computing task to be performed by the computing cluster. The instructions additionally cause the processor to determine a second portion of the computing task to be performed by a cloud service.

As used in the present specification and in the appended claims, the term “processor” may be a processor resource, a controller, an application-specific integrated circuit (ASIC), a semiconductor-based microprocessor, a central processing unit (CPU), and a field-programmable gate array (FPGA), and/or other hardware device that executes instructions.

As used in the present specification and in the appended claims, the term “memory” may include a computer-readable storage medium, which computer-readable storage medium may contain, or store computer-usable program code for use by or in connection with an instruction execution system, apparatus, or device. The memory may take many types of memory including volatile memory (e.g., RAM) and non-volatile memory (e.g., ROM).

As used in the present specification and in the appended claims,the term “data storage device” may include a non-volatile computer-readable storage medium. Examples of the data storage device include hard disk drives, solid-state drives, writable optical memory disks, magnetic disks, among others. The executable instructions may, when executed by the respective component, cause the component to implement the functionality described herein.

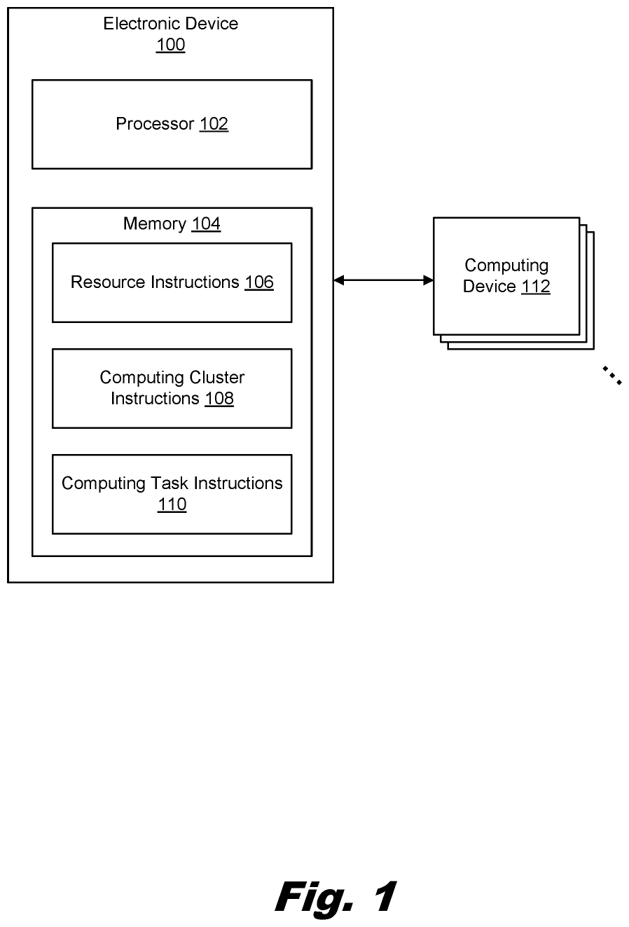

Turning now to the figures, FIG. 1 is a block diagram of an electronic device 100 to form a computing cluster based on available memory resources and processing resources, according to an example. As described above, the electronic device 100 includes a processor 102. The processor 102 of the electronic device 100 may be implemented as dedicated hardware circuitry or a virtualized logical processor. The dedicated hardware circuitry may be implemented as a central processing unit (CPU). A dedicated hardware CPU may be implemented as a single to many-core general purpose processor. A dedicated hardware CPU may also be implemented as a multi-chip solution, where more than one CPU are linked through a bus and schedule processing tasks across the more than one CPU.

A virtualized logical processor may be implemented across a distributed computing environment. A virtualized logical processor may not have a dedicated piece of hardware supporting it. Instead, the virtualized logical processor may have a pool of resources supporting the task for which it was provisioned. In this implementation, the virtualized logical processor may be executed on hardware circuitry; however, the hardware circuitry is not dedicated. The hardware circuitry may be in a shared environment where utilization is time sliced. Virtual machines (VMs) may be implementations of virtualized logical processors.

In some examples, a memory 104 may be implemented in the electronic device 100. The memory 104 may be dedicated hardware circuitry to host instructions for the processor 102 to execute. In another implementation, the memory 104 may be virtualized logical memory. Analogous to the processor 102, dedicated hardware circuitry may be implemented with dynamic random-access memory (DRAM) or other hardware implementations for storing processor instructions. Additionally, the virtualized logical memory may be implemented in an abstraction layer which allows the instructions to be executed on a virtualized logical processor, independent of any dedicated hardware implementation.

The electronic device 100 may also include instructions. The instructions may be implemented in a platform specific language that the processor 102 may decode and execute. The instructions may be stored in the memory 104 during execution. The instructions may include resource instructions 108, computing cluster instructions 108 and computing task instructions 110, according to the examples described herein.

In some examples, the processor 102 may execute resource instructions 106 that cause the processor 102 to determine the availability of memory resources and processing resources of multiple computing devices 112. As used herein, a computing device 112 may include a laptop computer, desktop computer, tablet computer, server, workstation, smartphone, router, gaming console, or other device having memory resources and processing resources.

In some examples, the computing devices 112 may periodically report about the state of their memory resources and processing resources. For example, the computing devices 112 may send a daily report of memory resource usage and processing resource usage. The reports from the computing devices 112 may indicate historical usage of the memory resources and processing resources by the computing devices 112. For example, the reports sent by the computing devices 112 may indicate an amount of resource usage and times when the memory resources and processing resources are being used. In some examples, the reports sent by the computing devices 112 may indicate an excess amount of memory resources and processing resources available. In other words, the computing devices 112 may indicate an amount of unused memory resources and processing resources that are available for forming a computing duster.

In some examples, the processor 102 may run an ML model that is trained to predict the availability of the memory resources and the processing resources of the multiple computing devices 112. As used herein, the terms “availability” and “available” refer to a computing resource (e.g., memory resources and processing resources) being in a state in which the computing resource can be used to perform a computing task. For example, if a computing resource is idle, then it may be available to perform a computing task. In another example, if a computing device 112 is using a portion of the memory resources and processing resources, then the remaining unused portion of the memory resources and processing resources may be available to perform a computing task.

In some examples, the ML model may be an artificial neural network (ANN). For example, the ML model may be an ANN forward propagation model. In other examples, the ML model may be another type of neural network such as convolutional neural network (CNN), recurrent neural network (RNN), etc.

The ML model may consider that a given user may be using an application on a computing device 112. The running application may utilize a certain amount of memory resources and processing resources to accomplish the given task. Using the historical usage data provided by the computing devices 112, the processor may combine the usage attributes to produce an input feature vector for the ML model to predict the availability of the memory resources and processing resources of the computing devices 112.

In some examples, the ML model may be trained to predict the availability of memory resources and processing resources of the multiple computing devices 112. For example, the ML model may predict the availability of the memory resources and processing resources based on historical usage of the memory resources and processing resources by the computing devices 112. For example, the ML model may predict, based on the reported historical usage, that a given computing device 112 may be available at a given time of day. Furthermore, the ML model may predict that a user of the computing device 112 may use certain amounts of memory resources and processing resources at certain times. Considering this usage data, the ML model may predict when given computing devices 112 will have available memory resources and processing resources. The ML model may also predict the amounts of memory resources and processing resources that will be available at a given time.

In some examples, the ML model may also predict the memory resource and processing resource usage for a given computing task. For example, the ML model may be trained to determine resource usage for a future computing task based on historical logs or benchmarks for similar computing tasks. The ML model may predict the amount of computing resources that will be used by the future computing task. The ML model may also predict the length of time that the computing resources will be used.

In some examples, the processor 102 may execute computing cluster instructions 108 that cause the processor 102 to form a computing cluster based on the availability of the memory resources and the processing resources. For example, once the ML model predicts the availability of the memory resources and processing resources, the processor 102 may decide whether and when to form a computing cluster using computing devices 112 that have available memory resources and processing resources.

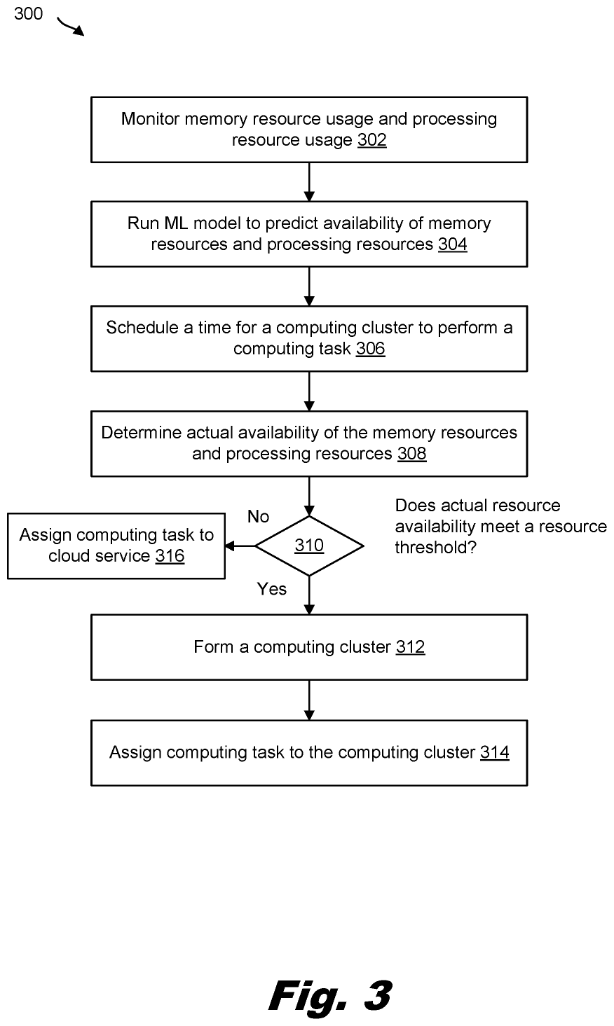

In some examples, the processor 102 may form the computing cluster as a virtual private cloud. In some examples, templates may be used to automate resource creation, allocation and termination of the computing cluster. In some examples, resource management for the computing cluster may be controlled by a virtual cloud formation service (e.g., AWS virtual cloud formation service) based on the resource prediction output by the ML model. An example of this approach is described in FIG. 3.

In some examples, the processor 102 may execute computing task instructions 110 that cause the processor 102 to assign a computing task to the computing cluster to replace a cloud service. For example, based on the predicted availability of the memory resources and processing resources, the processor 102 may schedule a computing task.

At the scheduled time for the computing task, the processor 102 may determine the actual availability of the memory resources and the processing resources of the multiple computing devices 112. For example, before forming the computing cluster to perform the computing task, the processor 102 may determine the amount of memory resources and processing resources that are currently available. The processor 102 may then determine whether the actual availability of the memory resources and the processing resources meets a resource threshold to perform the computing task. For example, a given computing task may use a threshold amount of memory resources and processing resources (i.e., resource threshold). If the actual availability of the memory resources and the processing resources is less than the resource threshold, then the processor 102 may assign the cloud service to perform the computing task.

If the actual availability of the memory resources and the processing resources is greater than the resource threshold, then the processor 102 may proceed with forming the computing cluster among the computing devices 112 that have available resources. In some examples, the processor 102 may coordinate with the multiple computing devices 112 to dedicate the memory resources and processing resources to perform the computing task. In some examples the processor 102 may obtain permission from a user of the computing device 112 before dedicating the memory resources and processing resources of the computing device 112 to the computing cluster.

In some examples, the processor 102 may select the computing devices 112 for the computing cluster from a pool of available computing devices 112 to balance a workload among the pool of available computing devices 112. For example, if there is a surplus of computing devices 112 available to perform a given computing task, the processor 102 may assign certain computing devices 112 to be in the computing cluster in a round robin fashion to balance the load efficiently among the computing devices 112. This may provide equal opportunity to the computing devices 112 to donate memory resources and processing resources.

Upon completion of the computing task, the processor 102 may release the memory resources and processing resources from the computing duster. For example, the processor 102 may remove the computing devices 112 from the computing cluster to free up the memory resources and processing resources that were reserved for the computing duster.

In some examples, the processor 102 may determine that the cloud service has a latency greater than a threshold latency. For example, the cloud service may be slow. In this case, it may be faster to perform a computing task on the computing cluster then on the cloud service. The processor 102 may form the computing cluster and assign the computing task to the computing cluster in response to determining that the cloud service has a latency greater than a threshold latency.

In some examples, the processor 102 may determine that the cloud service is unavailable. For example, the cloud service may crash or may be unreachable. In this case, processor 102 may form a computing cluster based on the availability of memory resources and processing resources. The processor 102 may then assign the computing task to the computing cluster.

In some examples, the processor 102 may determine whether to assign a computing task to a computing cluster or the cloud service. For example, the processor 102 may optimize a cost for using the cloud service and available computing resources to perform the computing task. The processor 102 may schedule a time for the computing cluster or the cloud service to perform the computing task based on this optimization analysis.

In some examples, the ML model may be trained to perform a scheduling optimization based on historical resource availability and cloud service costs. The ML model may determine when the predicted availability of the memory resources and processing resources meets a resource threshold to perform the computing task. If the ML model determines that the predicted availability of the memory resources and processing resources is insufficient to perform the computing task, then the processor 102 may assign the computing task to the cloud service.

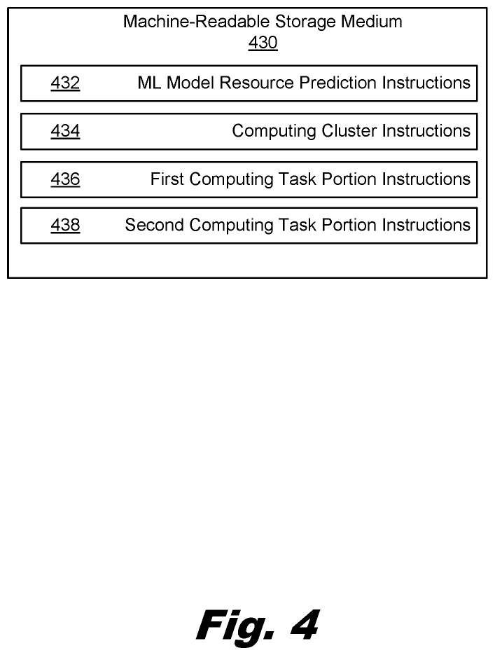

In some examples, the processor 102 may determine portions of a computing task that are to be performed on the computing duster and other portions of the computing task that are to be performed by the cloud service. For example, the processor 102 may determine a first portion of a computing task that is to be performed by the computing cluster. The processor 102 may determine a second portion of the computing task that is to be performed by the cloud service. An example of this approach is described in FIG. 4.

As described by these examples, the computing cluster may be used as a replacement for a cloud service to process a computing task. For example, heavy processing computing tasks may be scheduled on the computing cluster during the night when most of the computing devices 112 are in an idle state. These examples may also reduce cloud service processing costs and dependency on third-party cloud services.

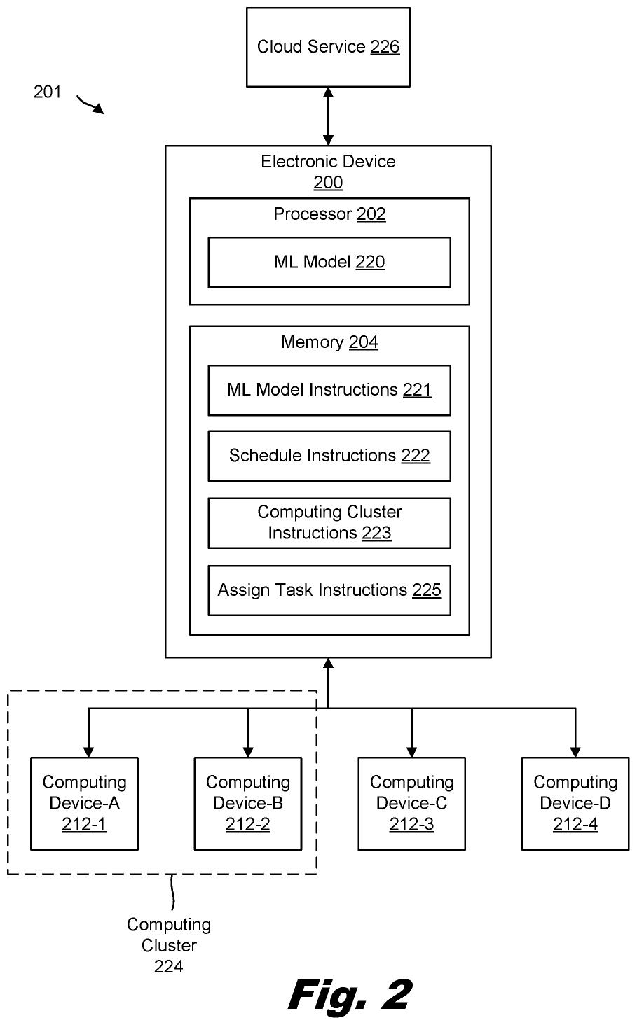

FIG. 2 is a block diagram illustrating a system 201 for generating a computing cluster 224, according to an example. The system 201 may include an electronic device 200 that may be implemented according to electronic device 100 of FIG. 1.

In some examples, the electronic device 200 may include a processor 202 and memory 204 storing instructions. In some examples, ML model instructions 221 may cause the processor 202 to run an ML model 220 trained to predict the availability of memory resources and processing resources of multiple computing devices 212-1, 212-2, 212-3, 212-4.

In an example, the ML model 220 may predict that computing device-A 212-1 and computing device-B 212-2 will have available memory resources and processing resources at a given time to perform a computing task. The ML model 220 may predict that computing device-C 212-3 and computing device-D 212-4 will not have available memory resources and processing resources at the given time.

In some examples, schedule instructions 222 may cause the processor 202 to schedule a computing task based on the predicted availability of the memory resources and the processing resources. The computing cluster instructions 223 may cause the processor 202 to form, responsive to scheduling the computing task, a computing cluster 224 based on actual availability of the memory resources and the processing resources. Assign task instructions 225 may cause the processor 202 to assign a computing task to the computing cluster 224 to replace a cloud service 226.

In an example, the processor 202 may schedule a time that the computing task is to run on a computing cluster 224 formed from computing device-A 212-1 and computing device-B 212-2. At the scheduled time, the processor 202 may form the computing cluster 224 from computing device-A 212-1 and computing device-B 212-2. In this case, the processor 202 may assign the computing task to the computing cluster 224 to replace the cloud service 226. In other words, the computing cluster 224 may be used to perform the computing task instead of the cloud service 226. In this example,

In another example, the ML model 220 may predict that none of the computing devices 212-1, 212-2, 212-3, 212-4 will have available memory resources and processing resources at a given time to perform a second computing task. In this case, the processor 202 may assign the computing task to be performed by a cloud service 226.

In yet another example, the ML model 220 may determine that a first portion of a computing task is to be performed by the computing cluster 224. For example, the ML model 220 may predict that the computing cluster 224 will have sufficient memory resources and processing resources to perform the first portion of the computing task at a given time. The ML model 220 may also determine a second portion of the computing task that is to be performed by the cloud service 226. The processor 202 may then assign the first portion of the computing task to the computing cluster 224 and the second portion of the computing task to the cloud service 226.

FIG. 3 is a flow diagram illustrating a method 300 for forming a computing cluster based on memory resources and processing resources, according to an example. In some examples, the method 300 may be performed by a processor, such as the processor 102 of FIG. 1.

At 302, memory resource usage and processing resource usage may be monitored for multiple computing devices. In some examples, multiple computing devices may send a report detailing use of memory resources and processing resources. In some examples, the computing device may report on their memory resource usage and processing resource usage on a periodic basis (e.g., hourly, daily, weekly, etc.).

In some examples, the computing devices may send a report with various features and attributes related to their historic memory resource usage and processing resource usage. Table 1 provides examples of attributes that a given computing device may report.

TABLE 1

| Data Category | Field |
|---|---|
| Hardware Inventory | Device Type |
| | Device Manufacturer |
| | Device Model |
| | Operating System |
| | Operating System Release |
| | Operating System Build No |
| | Operating System Edition |
| | Operating System Type |
| | Product SKU |
| | Last Seen |
| | Memory |
| | Graphics |
| | Processor |
| | Manufacture Date |
| | Born On Date |
| | Enrolled Date |
| | Country |
| | Operating System Full |
| | TPM Version (Manufacturer Version) |
| CPU | Detected |
| | Name |
| | Cores |
| | Cores Enabled |
| | Logical Processors |
| | Processor ID |
| | Data Width |
| | Max Clock Speed |
| | CPU Device ID |
| | L2CacheSize |
| | L3CacheSize |
| RAM | Capacity |
| | Data Width |
| | Device Locator |
| | Speed |
| | Total Width |
| | Detected |
| | Form Factor |
| | Manufacturer |
| | Memory Type |
| | Memory Sn |
| | Total Physical |
| | Free Physical |
| | Total Virtual |
| | Free Virtual |
| | Page File Space |
| | Max Capacity |
| | Error Correction |

It should be noted that while several different examples of memory resource usage and processing resource usage attributes are included in Table 1, a computing device may report a subset of these examples, or other types of usage data.

At 304, an ML model trained to predict availability of memory resources and processing resources of multiple computing devices may be run. In some examples, the reported usage data from the computing devices may be acquired. For example, the processor may receive the resource usage data directly from the computing devices or from a database storing the resource usage data.

The resource usage data may be used as input data for the ML model. In some examples, before the resource usage data is provided to the ML model, the resource usage data may be processed to get it in a state that the ML model can use. Feature vectors may be defined from the attributed included in the resource usage data. A filter may be applied to the dataset to get those attributes that were defined in the feature attributes table (e.g., Table 1). Also, the resource usage data may be cleaned to remove bad data or data that is not useful for the calculation. For example, data unrelated to RAM and CPU values may be removed.

In an example, the ML model may be implemented as an ANN forward propagation model. In this example, the input data (e.g., historical usage data) may be fed in the forward direction through the ML model. Each hidden layer of the ML model may accept the input data, may process the input data, and may pass the processed input data to the successive layer. From the given dataset prepared from the historical usage data, each of the independent features will be passed to the input layer of the ML model to act as input.

The forward propagation may be started by randomly initializing the weights of all neurons of the ML model. The weights may be depicted by the edges connecting the neurons. Hence the weights of a neuron can be more appropriately thought of as weights between two layers since edges connect two layers. Because the calculation of neurons may be independent of each other, they can be computed in parallel easily. The first hidden activation may be calculated simultaneously, then the activation of the second layer may be calculated simultaneously, and then the output may be calculated.

In some examples, during the training process of the ML model, weights may be adjusted to make actual outputs dose to the target outputs of the ML model. In some examples, a multilayer perceptron (MLP) may utilize a supervised learning technique called back propagation for training the ML model.

In some examples, to test the ML model, a leave one-out cross-validation and testing approach may be used. In this approach, data for one benchmark application may be left out of the training set and used to test the performance of the ML model. To eliminate bias, this testing may be performed iteratively for all benchmarks.

In some examples, the ML model may provide the predicted availability of the memory resources and processing resources in a list of attributes. An example of attributes generated by the ML model is illustrated in Table 2.

TABLE 2

| Data Category | Field |
|---|---|
| Device | Device_ID |
| | Date |
| | Daily_Used_CPU |
| | Daily_Used_RAM |
| | Is_CPU_Available_to_Donate |
| | Is_RAM_Available_to_Donate |
| | CPU_Available_Percentage |
| | RAM_Available_Percentage |
| | Can_Cluster_Be_formed |
| | Cloud_Service_Cost_Saving |

At 306, a time for a computing cluster to perform a computing task may be scheduled. For example, the processor may receive the predicted availability of the memory resources and processing resources from the ML model. Based on the amount of memory resources and processing resources that are available, the processor may select certain computing devices to form a computing duster. The processor may also select a time when the computing duster is to perform the computing task based on the predicted availability.

At 308, the actual availability of the memory resources and processing resources may be determined at the scheduled time. For example, at the time that the computing task is scheduled to be performed, the processor may check to see if the memory resources and processing resources are actually available on the computing devices selected for the computing cluster.

At 310, the processor may determine whether the actual availability of memory resources and processing resources meets a resource threshold for the computing task. For example, the ML model (or a second ML model) may predict a minimum amount of memory resources and processing resources that should be available to perform the computing task. This prediction may be the resource threshold for the computing task.

If the actual availability of memory resources and processing resources meets (e.g., is greater than) the resource threshold (310 determination YES), then a computing cluster may be formed at 312. At 314, the computing task may be assigned to be performed on the computing cluster. If at 310, the actual availability of memory resources and processing resources does not meet (e.g., is less than) the resource threshold (310 determination NO), then the computing task may be assigned to the cloud service, at 316.

In some examples, the computing cluster may be a virtual cloud formation using spot server resources. In some examples, the computing cluster may be formed using a cloud formation service (e.g., AWS CloudFormation).

Because the computing cluster and paid cloud services are separate, predefined templates may be used to automate the resource creation, allocation and termination of the computing cluster using a cloud formation service. For example, the cloud formation service may provide tools for creating and managing the computing cluster infrastructure. In some examples, the cloud formation service can perform actions that it has been granted permission to perform. Therefore, the permission may be added to the cloud formation service to create computing cluster instances, to terminate the computing cluster instances, and to configure the computing duster instances.

In a template, a computing cluster instance type may be defined based on how much data is to be processed by the computing cluster. For example, a template may define a first computing cluster instance type (t1), a second computing duster instance type (t2), and so forth. In some examples, the cloud formation service may help model memory resources and processing resources by describing these resources in a template that can be deployed as a stack on the cloud services.

In some examples, the memory present in the computing cluster may be used as object-based storage, block-based storage, caching-type storage, or a combination thereof. With regard to object-based storage, in some examples, objects (e.g., regular files or directories) may be stored in the computing cluster memory with a key and its value that is data along with its metadata. This will provide enhanced performance for computing tasks with a large content and high stream output. In this case, the data can be accessed readily because of the low latency due to the computing cluster location corresponding to the application location. Furthermore, the, computing cluster storage can scale with the availability of memory resources and processing resources in the computing cluster. With object-based storage, the customizable metadata allows data to be easily organized and retrieved.

In some examples, block-level storage may allow users to run operating systems on the computing cluster via a virtual machine by creating an Elastic Compute Cloud (EC2) instance. In some examples, block-based storage may be used as a storage for data that has frequent updates, such as the system drive or storage for a database application. In some examples, block-based storage may also be used for throughput-intensive applications that perform continuous disk scans, Block-based storage may automatically and instantly scale file system storage capacity up or down as files are added or removed without disrupting computing tasks performed by the computing cluster.

In some examples, to maintain synchronization and a strong connection between a computing cluster and cloud resources, cloud services such as storage gateway may be used. For example, storage gateway is a service that connects on-premises environments with cloud-based storage to integrate an on-premises application seamlessly and securely with a cloud storage backend, in some examples, volume gateway may be used to store virtual hard disk drives in the cloud. The storage gateway service may be either a physical device or a virtual machine (VM) image downloaded onto a host in an on-premises data center. The storage gateway service may act as a bridge to send or receive data from cloud services. To isolate the computing cluster from the cloud services and other applications, a virtual private setup may be used for the computing cluster that allows for provisioning a logically isolated section of the computing cluster where services and systems can be launched within a virtual network. By having the option of selecting which resources are public and which are not, this virtual setup for the computing cluster provides granular control over security.

FIG. 4 depicts a non-transitory machine-readable storage medium 430 for generating a computing cluster based on memory resources and processing resources, according to an example. To achieve its desired functionality, an electronic device 100 includes various hardware components. Specifically, an electronic device includes a processor and a machine-readable storage medium 430. The machine-readable storage medium 430 is communicatively coupled to the processor. The machine-readable storage medium 430 includes a number of instructions 432, 434, 436, 438 for performing a designated function. The machine-readable storage medium 430 causes the processor to execute the designated function of the instructions 432, 434, 436, 438. The machine-readable storage medium 430 can store data, programs, instructions, or any other machine-readable data that can be utilized to operate the electronic device 100. Machine-readable storage medium 430 can store computer readable instructions that the processor of the electronic device 100 can process or execute. The machine-readable storage medium 430 can be an electronic, magnetic, optical, or other physical storage device that contains or stores executable instructions. Machine-readable storage medium 430 may be, for example, Random Access Memory (RAM), an Electrically Erasable Programmable Read-Only Memory (EEPROM), a storage device, an optical disc, etc. The machine-readable storage medium 430 may be a non-transitory machine-readable storage medium 430, where the term “non-transitory” does not encompass transitory propagating signals.

Referring to FIG. 4, ML model resource prediction instructions 432, when executed by the processor, may cause the processor to run a ML model trained to predict availability of memory resources and processing resources of multiple computing devices. Computing cluster instructions 434, when executed by the processor, may cause the processor to form a computing cluster based on the predicted availability of the memory resources and processing resources of multiple computing devices. First computing task portion instructions 436, when executed by the processor, may cause the processor to determine a first portion of a computing task to be performed by the computing cluster. Second computing task portion instructions 438, when executed by the processor, may cause the processor to determine a second portion of the computing task to be performed by a cloud service.

In some examples, the first portion of the computing task may include computation of data. In this case, computation-heavy tasks may be performed by the computing cluster. In some examples, the second portion of the computing task may include storing a final output by the cloud service. For example, the results produced by the computing cluster may be sent to the cloud service for storage. In some examples, the cloud service may make the results available for use by other applications.

In some examples, the processor 102 may run a first ML model trained to predict availability of memory resources and processing resources of multiple computing devices, as described above. The processor 102 may also run a second ML model trained to determine the first portion of the computing task for the computing cluster and the second portion of the computing task for the cloud service based on the predicted availability the memory resources and processing resources. For example, the second ML model may determine that the first portion of the computing task is a computation-intense process that is well-suited to the computing duster. The second ML model may further determine that the second portion of the computing task is a data storage process that is suited for the cloud service.

What is claimed is:

1. An electronic device, comprising:
a processor; and
a memory communicatively coupled to the processor and storing executable instructions that when executed cause the processor to:
determine availability of memory resources and processing resources of multiple computing devices;
form a computing cluster based on the availability of the memory resources and the processing resources; and
assign a computing task to the computing cluster to replace a cloud service.

2. The electronic device of claim 1, wherein the executable instructions to determine the availability of the memory resources and the processing resources comprise executable instructions to cause the processor to:
run a machine-learning (ML) model that is trained to predict the availability of the memory resources and the processing resources of the multiple computing devices.

3. The electronic device of claim 1, wherein the executable instructions to assign the computing task comprise executable instructions to cause the processor to:
determine that the cloud service has a latency greater than a threshold latency.

4. The electronic device of claim 1, wherein the executable instructions to assign the computing task comprise executable instructions to cause the processor to:
determine that the cloud service is unavailable to perform the computing task.

5. The electronic device of claim 1, wherein the executable instructions to assign the computing task comprise executable instructions to cause the processor to:
schedule a time for the computing cluster to perform the computing task based on optimizing a cost for using the cloud service and available computing resources to perform the computing task.

6. An electronic device, comprising:
a processor; and
a memory communicatively coupled to the processor and storing executable instructions that when executed cause the processor to:
run a machine-learning (ML) model trained to predict availability of memory resources and processing resources of multiple computing devices;
schedule a computing task based on the predicted availability of the memory resources and the processing resources;
form responsive to scheduling the computing task, a computing cluster based on actual availability of the memory resources and the processing resources; and
assign the computing task to be performed by the computing cluster.

7. The electronic device of claim 6, wherein the ML model is to predict the availability of the memory resources and processing resources based on historical usage of the memory resources and processing resources by the computing devices.

8. The electronic device of claim 6, wherein the executable instructions to schedule the computing task comprise executable instructions to cause the processor to:
schedule the computing task at a time when the predicted availability of the memory resources and processing resources meets a resource threshold to perform the computing task.

9. The electronic device of claim 6, wherein the executable instructions to form the computing cluster comprise executable instructions to cause the processor to:
determine the actual availability of the memory resources and the processing resources of the multiple computing devices;
determine that the actual availability of the memory resources and the processing resources meets a resource threshold to perform the computing task; and
coordinate with the multiple computing devices to dedicate the memory resources and processing resources to perform the computing task.

10. The electronic device of claim 6, wherein the executable instructions further comprise executable instructions to cause the processor to:
release the memory resources and processing resources from the computing cluster upon completion of the computing task.

11. The electronic device of claim 6, wherein the executable instructions further comprise executable instructions to cause the processor to:
select the computing devices for the computing cluster from a pool of available computing devices to balance workload among the pool of available computing devices.

12. A non-transitory computer readable medium comprising machine readable instructions that when executed cause a processor to:
run a machine-learning (ML) model trained to predict availability of memory resources and processing resources of multiple computing devices;
form a computing cluster based on the predicted availability of the memory resources and processing resources of multiple computing devices;
determine a first portion of a computing task to be performed by the computing cluster; and
determine a second portion of the computing task to be performed by a cloud service.

13. The computer readable medium of claim 12, wherein the instructions further comprise executable instructions to cause the processor to:
run a second ML model trained to determine the first portion of the computing task for the computing cluster and the second portion of the computing task for the cloud service based on the predicted availability the memory resources and processing resources.

14. The computer readable medium of claim 12, wherein the first portion of the computing task comprises a computation of data by the computing cluster.

15. The computer readable medium of claim 12, wherein the second portion of the computing task comprises storing a final output by the cloud service.
